(19) United States
(12) Patent Application Publication
(10) Pub. No.: US 2023/0046426 A1
(43) Pub. Date: Feb. 16, 2023

(54) ONLINE ADVERTISING TRACKING

(71) Applicant: ZACT, INC., Saratoga, CA (US)

(72) Inventors: Gopalakrishnan HARIHARAN, Highlands Ranch, CO (US); John K. THOMAS, Saratoga, CA (US)

(21) Appl. No.: 17/768,959

(22) PCT Filed: Dec. 23, 2020
(86) PCT No.: PCT/US20/66889

§ 371 Date: Apr. 14, 2022

Related U.S. Application Data
(60) Provisional application No. 62/985,463, filed on Mar. 5, 2020.
(60) Provisional application No. 62/953,053, filed on Dec. 23, 2019.

(51) Int. Cl. G06Q 30/02

(52) U.S. Cl. CPC G06Q 30/0246; G06Q 30/0277

(57) ABSTRACT

A verification system is provided that can enable tracking of online advertisements with successful sales of goods or services. The system can receive an advertisement tag as part of a request by a user relating to the product or service, the advertisement tag comprising an identity of a publisher of an advertisement regarding a product or service offered by a vendor, the publisher being different from the vendor; determine a contribution of the publisher's advertisement to the request; and update a set of transaction data structures in an electronic record to associate the identified publisher and contribution with the request.

### CROSS-REFERENCE TO RELATED APPLICATIONS

This application claims the benefits of U.S. Provisional Application Nos. 62/953,053 filed Dec. 23, 2019; and U.S. Provisional Application No. 62/985,643 filed Mar. 5, 2020, the disclosures of each of which are incorporated herein by reference in their entireties.

### FIELD OF THE DISCLOSURE

The disclosure relates generally to advertisement tracking systems and particularly to online advertisement tracking systems.

### BACKGROUND

Online advertising is a proven way to target and reach audiences with concise messaging. Online advertising can afford certain benefits that business marketers can leverage: for example, advertise only to those in the target audiences, with easily-customizable, specific messaging, since “online” is where customers are; track effectiveness via metrics demonstrating an ad's impact on traffic to the website or other measures, then modify in real-time as needed; and businesses of any size and type can participate—e-commerce business (sells only online); local/regional service or product business (for customers in a specific location, i.e., retail stores, restaurants, physicians, etc.); or non-geographic services (not limited by location, such as consulting or IT support).

Most businesses structure and pay for online ads in one of two ways: pay-per-click advertising or fixed rate advertising. Pay-per-click (PPC) is paying for an ad based solely on the amount of clicks it gets. A business can post multiple versions of the same ad and quickly see which gets the most clicks and make changes as needed. This is effective for those with a strict budget, as spending limits can be preset. Fixed Rate is when businesses pay a set price for ads up front and is used often on content-focused sites where the target audience is likely already there. In both cases, the ‘click’ goes to the business's homepage or a content-specific landing page. These fee structures can cause vendors and other businesses to pay substantial amounts for web advertisements regardless of sales revenue generated by the advertisements or advertisement context.

### SUMMARY

In certain embodiments, the present disclosure relates to a method, comprising the steps: generating, by a processor, a token comprising information describing one or more of a product or service provided by a vendor and the vendor and an advertisement tag, the advertisement tag comprising an identity of a publisher of an advertisement regarding the product or service, the publisher being different from the vendor; as part of a request by a user relating to the product or service, receiving, by the processor, the token; determining, by the processor, a contribution of the publisher's advertisement to the request; and updating, by the processor, a set of transaction data structures in an electronic record to associate the identified publisher and contribution with the request.

In certain embodiments, the present disclosure relates to a system, comprising: a processor; and a memory coupled with and readable by the processor and storing therein a set of instructions which, when executed by the processor, causes the processor to:

generate a token comprising information describing one or more of a product or service provided by a vendor and the vendor and an advertisement tag, the advertisement tag comprising an identity of a publisher of an advertisement regarding the product or service, the publisher being different from the vendor;

receive the token as part of a request by a user relating to the product or service;

determine a contribution of the publisher's advertisement to the request; and

update a set of transaction data structures in an electronic record to associate the identified publisher and contribution with the request.

In certain embodiments, the present disclosure relates to a system including a processor and a memory coupled with and readable by the processor and storing therein a set of instructions which, when executed by the processor, causes the processor to:

receive an advertisement tag as part of a request by a user relating to the product or service, the advertisement tag comprising an identity of a publisher of an advertisement regarding a product or service offered by a vendor, the publisher being different from the vendor;

determine a contribution of the publisher's advertisement to the request; and

update a set of transaction data structures in an electronic record to associate the identified publisher and contribution with the request.

The request can be part of a sales transaction for the product or service, the token can be included in the advertisement, and the publisher can be one or more of an Internet Service Provider (ISP) and search engine.

The contribution can be a monetary charge for the advertisement, and the information in the token can comprise a unique identifier of the vendor providing the product or service and a product or service identifier of the product or service.

The processor can provide the token to a computational system associated with the vendor or the publisher, receive from a user device associated with the user and as part of an electronic session and transaction, a user identifier and the token included in the advertisement selected by the user device, authenticate the user identifier, as part of the transaction, and, when the user is authenticated by the processor successfully, provide an authorization to a financial system associated with the user to cause payment from an account of the user to an account of the vendor.

The processor can receive a response from the financial system indicating payment by the user for the product or service, and in response to receipt of the financial system response, providing, by the processor, at least part of the response to the vendor system, the at least part of the response comprising an identity of a publisher of the advertisement, an identifier of an advertisement mechanism associated with the advertisement, and/or a descriptor of a context of the advertisement and a product or service identifier of the product or service and an electronic session identifier associated with the electronic session and/or a transaction identifier associated with the transaction to cause the vendor system to authorize provision of the product or service to the user.

The advertisement can be included in a search engine results page and the advertisement tag can further include an identifier of an advertisement mechanism associated with the advertisement, the advertisement mechanism being a banner ad, sidebar ad, pop-up ad, pop-under ad, floating ad, unicast ad, streaming ad, pull-up ad, pull-down ad, and combination thereof.

The advertisement can be included in a web page of a web site, the web page can contain the token in a field defined by hypertext markup language, the advertisement tag can comprise one or more descriptors of a context of the advertisement, and the one or more descriptors can describe a sequence of clicks by the user and a search history of the user.

The advertisement can be a printed or displayed advertisement, and the processor can receive the token from the user device as an image or as input from a customer service representative.

The token can comprise or be concatenated with a second advertisement tag comprising a different second publisher, the second publisher being responsible for a second web page provided to a user device during navigation by the user from the web page of the web site.

The present disclosure can provide a number of advantages depending on the particular aspect, embodiment, and/or configuration. These and other advantages will be apparent from the disclosure.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of an embodiment of a system according to this disclosure;

FIG. 2 is a block diagram of a verification system according to this disclosure;

FIG. 3 is a block diagram of an embodiment of a data structure according to this disclosure;

FIG. 4 is a message flow diagram of a process for transaction with a vendor;

FIG. 5 is logic flow diagram of an embodiment of a process according to this disclosure;

FIG. 6 is a logic flow diagram of an embodiment of a process according to this disclosure;

FIG. 7 is a block diagram of hardware for the verification system according to the present disclosure; and

FIG. 8 is a block diagram of hardware for the verification system according to the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

To provide a more accurate linkage between an advertisement (e.g., an advertisement of a website) and product or service sales revenue therefrom, a verification system or vendor system can generate a token including not only a product or service identifier of an associated product or service in an advertisement and/or other product or service identifier data structures and associated vendor and/or other vendor data structures but also (or additionally) an advertisement tag that identifies the source advertisement responsible for the sale or a product or service referenced in the advertisement. The advertisement tag can include an identifier of a publisher of the source advertisement, an identifier of an advertisement mechanism for the source advertisement, and one or more descriptors of the context of the source advertisement. Stated differently, the verification system can determine, for each advertisement of a vendor's products or services, whether associated with or sponsored by the vendor or a third party, an associated identifier of a publisher system responsible for the selected advertisement, an identifier of an advertisement mechanism associated with the selected advertisement, and the descriptor(s) of the context of the selected advertisement.

In some embodiments, the verification system can not only uniquely combine public credentials (known to everybody) with distributed, encrypted systems, out of band communications and multi-factor authentication to facilitate the transfer of products and services in a more secure manner that is difficult to compromise but also link sales revenue directly and closely with customer access and/or selection of advertisements, thereby enabling vendors to pay amounts for advertisements based on sales revenue generated directly by the advertisements or advertisement context rather than on a mere estimate of an advertisement's sales impact provided by the Pay-Per-Click or Fixed Rate cost structure.

In some embodiments, the verification system can enable tracking web-based and other types of advertisements with associated successful sales of goods or services. The verification system can enable a vendor system to determine advertisement avenue(s) or modalities that are most effective to reach customers. This can offer substantial benefits to the vendor and customer. The major online advertising options can offer, at a reasonable cost determined by the verification system, enough variety so businesses of any size, type, and budgetary constraints can conduct an ad campaign that suits their needs. By charging for an advertisement's actual impact on completed sales, businesses can more accurately determine the cost benefit of online advertising, such as weighing the actual cost against the ability to contact a target audience, with easily-customizable, specific messaging; track effectiveness via metrics demonstrating an ad's impact on traffic to the website or other measures; or enable businesses of any size and type to participate—e-commerce business (sells only online); local/regional service or product business (for customers in a specific location, i.e., retail stores, restaurants, physicians, etc.); or non-geographic services (not limited by location, such as consulting or IT support).

For example, a search engine or internet service provider (e.g., the publisher) can provide a product or service advertisement in a search engine results page or SERP that includes a token comprising the advertisement tag or the advertisement tag itself. The advertisement is selected for display on the SERP in response to a search query, such as by an ad auction or automated process that determines the relevance and validity of advertisements that appear on SERPs. The advertisement tag identifies the publisher (e.g., search engine or ISP) and advertisement mechanism (e.g., paid search advertisement, display advertisement, banner ad, etc.). When a user device clicks on a web page link in the SERP to request a further web page, the publisher system requests from a host web server the linked web page associated with the selected link. The request includes the advertisement tag to track the activity of the user device after selecting the link on the source advertisement. The advertisement tag is transmitted through the network to the host server of the linked web page as part of the request and optionally included in the linked web page. As the user device selects further linked or cross-linked pages, the advertisement tag can be updated by any network node handling the request to include further advertisement information and the updated advertisement tag included in the further linked or cross-linked web page(s). When and as the user device navigates to a web page from which the user consummates a purchase of the product or service, the advertisement tag can be used to determine a contribution of the SERP publisher and optionally of advertisements in the intermediate web pages of the same or other publishers to a selected sale of a product or service. Other publishers can be involved in the navigation process and the advertisement tag can be modified to include an identity of each such publisher and the advertisement mechanism of the advertisement of the respective publisher in an intermediate web page. The advertisement tag is eventually received by the vendor's website as part of a request regarding purchase of the product or service and provided by the vendor system to the user device along with a token comprising the advertisement tag or directly to the verification system. The search engine or ISP can use search engine optimization to enhance the selection of advertisements for SERPs.

In another example, the advertisement is in a website, such as a blog, discussion board, Ecommerce, or other web site and may or may not be located by the user through an ISP or search engine. The publisher is commonly the web site host. When a user device clicks on a web page link in the displayed web page to a further web page, the publisher system requests from the host web server the linked web page associated with the selected link. The request includes the advertisement tag to track the activity of the user device after selecting the link on the source advertisement. The advertisement tag is transmitted through the network to the host server of the linked web page as part of the request and optionally included in the linked web page. As the user device selects further linked or cross-linked pages, the advertisement tag can be updated by any network node handling the request to include further advertisement information and the updated advertisement tag included in the further linked or cross-linked web page(s). When and as the user device navigates to a web page from which the user consummates a purchase of the product or service, the advertisement tag can be used to determine a contribution of the web page publisher for the source advertisement and optionally of advertisements in the intermediate web pages or the same or other publishers to a selected sale of a product or service.

Other publishers can be involved in the navigation process and the advertisement tag can be modified to include an identity of each such publisher and the advertisement mechanism of the advertisement of the respective publisher in an intermediate web page. The advertisement tag is eventually received by the vendor's website as part of a request regarding purchase of the product or service and provided by the vendor system to the user device along with a token comprising the advertisement tag or directly to the verification system. The verification system can use the advertisement tag and the information contained therein to determine a relative contribution of each identified publisher for purposes of payment. In one configuration, the publisher responsible for the initial web page selected by the user receives a greater payment (due to its greater perceived value contribution) than publishers responsible for providing thereafter during the browsing session intermediate web pages that eventually culuminate in the sale.

In some configurations, the advertisement is pushed, such as by a text, email, or SMS message, to the user device using geotargeting or geofencing, with the entity responsible for pushing the advertisement being the publisher. As will be appreciated, geotargeting of web content in Internet marketing and geomarketing is the method of determining the geolocation (the physical location) of a website visitor with geolocation software and delivering different content to that visitor based on his or her location, such as country, region/state, city, metro code/ZIP code, organization, Internet Protocol (IP) address, ISP, or other criteria.

The advertisement tag can be itself linked or cross-linked to an associated web page link or otherwise incorporated into a hidden or displayed field of the web page. For example, the advertisement tag and/or token can be in a field described in hypertext markup language (HTML) that defines the web page. As will be appreciated, HTML is the set of markup symbols or codes inserted into a file or web page intended for display on the Internet. The markup tells web browsers how to display a web page's words and images. The field, for instance, can be hidden or displayed and can be part of a link, text or other content (e.g., typography, image, or meta data), form control or element, and/or a tag, such as a meta tag and/or alt tag.

In another example, a user, via a user device, provides, such as by mobile device scanning or capturing a picture or by manual entry into a computation device, the token and/or advertisement tag, which is part of a printed or displayed advertisement. The token can be in the form of a visible numeric, alphanumeric, byte/binary or kanji) code, such as a barcode, Quick Response code (“QR code”), radio frequency tag (“RFID”), and the like). In one configuration, the token is a QR code that is captured by a scanner in a smartphone or other handheld device and converted in part to a website universal resource locator (“URL”) (with the other part being the advertisement tag that is appended to or incorporated into the request to the URL for further information. QR codes storing addresses and URLs may appear in magazines, on signs, on buses, on business cards, or on almost any object about which users might want information. Users with a camera phone equipped with the correct reader application can scan the image of the QR code to hardlink or object hyperlink to display text, contact information, connect to a wireless network, or open a web page in the telephone's browser. As part of a product or service order, the token and/or advertisement tag can be provided to the vendor directly (such as by phone, email, text, and the like) or indirectly through one or more intermediate Internet nodes. The token links the publisher of the printed or displayed advertisement with the sale.

When a browsing session is interrupted and discontinuous, the advertisement tag can be saved as part of an HTTP cookie (also called web cookie, Internet cookie, browser cookie, or simply cookie) on a user device. As will be appreciated, the cookie is a small piece of data stored on the user's computer by the web browser while browsing a website. Cookies were designed to be a reliable mechanism for websites to remember stateful information (such as items added in the shopping cart in an online store) or to record the user's browsing activity (including clicking particular buttons, logging in, or recording which pages were visited in the past).

In another example, the token is generated during the sales transaction using an advertisement tag that is provided with the product or service order. The advertisement tag can be included, for instance, in an online order or electronic session.

In some embodiments, the verification system receives, directly or indirectly from the user device associated with a user and/or as part of an electronic session and transaction, a user identifier, product or service-related code and/or the token embedded or included in the advertisement selected by the user device and authenticates the user identifier, as part of the transaction, to bind the user to the transaction. When the user is authenticated by the verification system successfully, the verification system can provide an authorization code or other authorization to a financial system associated with the user to cause payment from an account of the user to an account of the vendor. In some embodiments, when the user is authenticated by the verification system successfully, the verification system provides an approval code to the vendor system, the approval code comprising the product or service identifier of the associated product or service and the unique identifier of the vendor or the vendor system or an electronic session identifier associated with the electronic session, and a transaction identifier associated with the transaction to cause the vendor system to authorize provision of the associated product or service to the user. The token can be generated by the verification system by one or more of a random number generator, a pseudo-random number generator, and cryptographic hash algorithm.

The verification system can itself determine or enable a vendor or publisher system to determine a contribution of an advertisement to the sale of a product or service. In one configuration, the verification system can cause disbursement of a part of the transaction sales proceeds to a publisher system associated with an advertisement directly responsible for the sale. The verification system's linkage or association of the identifier of an advertisement mechanism and/or modality, identifier of a publisher or source of the advertisement, and/or one or more descriptor(s) of the context of the advertisement with the transaction can enable it to invoice, on behalf of the publisher system, the vendor for the advertisement actually causing the sale. It can also or additionally update a set of advertisement data structures in a distributed ledger to reflect the transaction details or data structures (e.g., vendor identity, date and amount of sale, identifiers or products or services sold, and purchaser or user details (such as the user identity)).

The verification system can generate an invoice to each vendor setting forth, for each transaction handled by the verification system, the identifier of an advertisement mechanism, identifier of a publisher of the advertisement, and/or descriptor of the context of the advertisement transaction details and the transaction details or data structures along with a charge for the use of the corresponding advertisement mechanism. When payment is received from the vendor, the verification system can reimburse the publisher of the advertisement for the vendor advertisements accessed by the user in performing the transaction.

The publisher system can be any computational device or system used by a publisher to publish advertisements, such as web-based advertisements, television advertisements, radio advertisements, or paper advertisements. The publisher system can use one or more advertisement mechanisms to advertise a product or service associated with a vendor system. The publisher system can be any web publication platform, such as a search engine, social media site, E-commerce site, content site, or other publisher of web advertisements.

There are many types of advertisement mechanisms, such as banner ads, sidebar ads, pop-up and pop-under ads, floating ads, unicast ads, streaming ads, pull-up and pull-down ads, and combinations thereof. Specific examples include: Google Adwords (which ads appear on Google™ search result pages, on the side of the displayed search results content, for businesses pertaining to the search criteria and accounting for the demographic parameters—these are usually PPC ads and are effective for campaigns based on specific keywords), search ads (which are similar to Google Adwords, except these ads appear as search results (usually top results) instead of on the side), Google display and content networks (which are similar to Google Adwords and go on sites related to a business), display ads (which are classic ads, such as banner ads, that are distributed to several different related websites. Instead of waiting for users to search certain terms, they automatically appear on sites where users who may be interested likely visit), social media ads (which are paid ads on social media sites such as Facebook™ and Twitter™), business directories (which are published by sites like Yelp™ that are designed to help people find a businesses), Yahoo Bing ads (which are similar to Google Adwords and Google Display ads, except that the ads are on the Yahoo Bing network), and collection ads, dynamic ads, lead generation ads and messenger ads of social network sites such as Facebook™. Other advertisement mechanisms include TV commercials, billboards, newspaper or other printed advertisements, a radio broadcast advertisement, an internet website page, or an advertisement sent to a mobile phone or other communication device.

In some embodiments, the token itself enables pairing of an advertisement with a successful sales transaction by including the advertisement tag. As noted, the advertisement tag commonly includes a publisher identifier of the publisher system responsible for the advertisement, advertisement mechanism identifier identifying the advertisement mechanism for the advertisement, and one or more context descriptor(s) describing context surrounding the advertisement's role in the sale transaction.

The publisher identifier can include not only a unique identifier of the publisher (such as entity name (e.g., American Online™ (AOL), CompuServe™, Earthlink™, MindSpring™, Google™, Yahoo!™, DuckDuckGo™, etc.) but also a type of publisher (e.g., Internet Service Provider, Internet search engine, etc.).

The advertisement mechanism identifier includes the type of advertisement mechanism, such as a banner ad, sidebar ad, pop-up ad, pop-under ad, floating ad, unicast ad, streaming ad, pull-up ad, pull-down ad, bill board or other signage, hand bill, radio broadcast, television advertisement, text, email or SMS message, or catalog.

The context descriptor can describe a context or setting in which the advertisement is presented to a user. For example, the context descriptor can describe content presented with the selected advertisement, such as content presented to the user's web browser with the advertisement, appearance of the advertisement (e.g., colors and dimensions of the advertisement), and other contextual information of interest to the fulfillment system.

The context descriptor of the context of the advertisement can take many forms. By way of nonlimiting example, it can describe a location or geolocation of the user at a selected point in time such as when the advertisement is selected, an action being performed by the user when the advertisement is selected, an action previously performed, currently being performed, or to be performed by the user (e.g., shopping at a certain store, traveling by a specified type of travel (e.g., riding in a Yellow™ cab or flying on an identified flight serviced by United Airlines™ to a specified destination and other flight information), outcome of transaction, and/or other circumstances that form the setting of an event (e.g., viewing or selecting a product or service or offer code in an advertisement) and in terms of which the event can be understood, assessed or analyzed (e.g., a type or location of the advertisement, a seating location of the user on a bus, train or airplane, restaurant or bar, or other venue where the advertisement was viewed, and the like). Further examples in online commerce include the search history and/or click tracking data associated with the web session giving rise to the transaction.

The context descriptor can be generated and/or modified not only by the verification system, user device, financial system, publisher system and/or vendor system but also by any intermediate node therebetween involved in the transaction or otherwise handling communications related to the transaction. The context descriptors can be a part of a vendor token or concatenated in a string along with the publisher identifier, advertisement mechanism identifier, the vendor system identifier tag, and/or product or service identifier and/or attached to the token.

The token can include additional information, such as the contact information of the identified publisher, publication charges (e.g., price for each sale associated with the advertisement) and other invoice information, and the like.

The token can be generated by the verification system in the manner set above. For example, the publisher identifier, advertisement mechanism identifier, and/or context descriptor(s) can be used by the verification system as a seed value to generate the token. Alternatively, the publisher identifier, advertisement mechanism identifier, and/or context descriptor(s) can be included as part of or concatenated with the vendor system identifier, product or service identifier, a third party identifier, and/or other transaction information. The token may be generated by the verification system before the transaction and embedded in the advertisement and/or during the transaction.

While examples are discussed with reference to online or web-based advertising, other types of digital and non-digital advertisements can benefit from the tracking ability of the verification system, such as display ads (e.g. digital ads using search engine optimization techniques to reach a target audience), social media ads, newspapers, catalogs, and magazines, outdoor advertising (e.g., billboards, posters, transit ads, handbills, ticket, product label, and other printed media), radio and podcasts, direct mail and personal sales, video ads, product placement, event marketing, and email or electronic message marketing.

The verification system can provide a Credential Authority (CA) function that issues credentials as part of tokens but, unlike current systems where the token is issued to the user, the verification system issues the token to a vendor system or third party interacting with the vendor system.

The verification system can also provide a Credential Reviewing Authority (CRA) function. The CRA function receives the token from the vendor system. The user has received the credential from the vendor system, which in turn received the credential from the CA function.

In addition to the token, the verification system can also receive additional information from the user. Such additional information might include a username, password, personal identification information (mother's maiden name) or other information broadly described, as something the user knows. The additional information might also include information about the user device (that is used to transmit the credential to the CRA function) and such information might include a user device identifier (for example, the CPU ID, the IMEI number of a mobile device, the SIM ID, a network ID such as those provided by operators of mobile networks), an application identifier like a serial number, or a synchronized counter (such as the RSA token and its variants) or other such information that is broadly classified as something the user has. Furthermore, the additional information provided with the credential may have to do with something the user is. Examples of such information include unique traits associated with the user such as fingerprints, facial attributes, voiceprints, retina scans or any other biological or physiological feature that is uniquely attributable to the user. Another aspect of something the user is has to do with the location of the user and the continuity of location. A user being located at a known location, a predicted location, or at a projected location all contribute to the authenticity of the user. On the other hand, an unknown or unexpected location might indicate potential for concern regarding authenticity and this concern can prompt a fraud mitigation subsystem to require further authentication.

In some applications, the user transfers the credential or additional information to the verification system through a connected user device. Examples of connected user devices include, but are not limited to, phones, smart phones, tablet computers, laptop and personal computers, streaking devices, game consoles, music systems, servers as well as wearable devices such as glasses, smartphones and others. The user device may operate independently or in conjunction with other user or non-user devices.

A secure hardware trusted computing environment (e.g., a trusted or secure network or secure channel in an untrusted or insecure network) can be used to ensure that the credential and additional information sent to the verification system is encrypted and signed using one or more keys and/or certificates connected to or derived from a hardware root of trust (e.g., the user device). Leveraging the hardware root of trust (e.g., an unmodifiable unique identifier or characteristic of the user device or derivative thereof) and the secure hardware trusted computing environment can ensure security, authenticity, tamper resistance, and deter theft of any and all information sent to the verification system. The leverage can be done, for example, by using (without limitation) a CPUID (e.g., an unmodifiable unique identifier associated with a central processing unit), International Mobile Equipment Identity (“IMEI”) number, SIMID (or International Mobile Subscriber Identity), Network ID (e.g., a portion of the TCP/IP address that is used to identify individuals or devices on a secure or unsecured network (such as a local area network or the Internet)), username/password, personal identification information, biometrics, validation of biometrics (such as from a system like TouchID) and others. The information can be used alone, as a digital signature, to generate a unique digital key or certificate, and/or as an input to an encryption algorithm to encrypt selected sensitive information.

In one example, a public key (“pubKey”) (such as a public blockchain address) is equivalent to a variable “G” times a private key (“privKey”). Typically, the privKey is a random or pseudorandom 256 bit number that is stored as an encrypted value. Owning the privKey establishes conclusively ownership of a transaction. The variable “G” is generally a function of a selected modulus M and a base point (p₁, p₂). As will be appreciated, pubKey can be calculated from privKey using elliptic curve multiplication, which is irreversible: K=k*G where k is privKey, G is a constant point called the generator point, and K is pubKey. The initial G is generally a predetermined point on a specific elliptic curve y\hat{ }2=(x\hat{ }3+7) that can be the same for all pubKeys. Accordingly, privKey is mathematically and irrevocably linked to the pubKey.

Using a root of trust, the privKey is not required to be random but can be verifiably linked to the root of trust so that owning the root of trust establishes conclusively the transit of the key and other information through the device identified by the root of trust which in turn has been verifiably linked to the owner of the privKey or exists in a trusted environment (example, without limitation, the TSA terminal/passport office examples noted below). Accordingly, owning the root of trust establishes conclusively ownership of the privKey through transit association to the user device as mentioned below.

The privKey can be random or pseudorandom. The root of trust can be used directly to encrypt the privKey or indirectly through a certificate and key linked to the root of trust.

The foregoing options can be used alone or collectively depending on the application.

Using the secure hardware trusted computing environment and the hardware root of trust can also establish the origin of the message to a selected user device thereby establishing lineage or association of the user to the user device.

A software implementation of the root of trust and secure trusted computing environment can also be used as well as any combination of hardware and software versions of the trusted computing environment and the root of trust.

Depending on the application, the verification system and/or financial system can provide an authentication system (AS) function that provides an organization with the user's information to validate the authenticity of the user. The CA, CRA and AS functions act collectively as a Secure Service Provider (SSP).

When the verification system provides the AS function, a counter-part to the AS function can reside at the financial system and can be referred to as the Counter Authentication System (CAS) function, and this system either remains in the control of the financial system or could be external to the financial system or it could be part of the SSP. Unlike current authentication systems, the AS function never gets or retains a user's uniquely identifiable restricted information such as name, date of birth, government issued identifiers like social security numbers, driver's license numbers, passport numbers, address and other such identifiers. All such restricted information regarding the user unique identity is only at the financial system. Even the CAS function may not see such restricted information and may have a surrogate identifier for the user. The surrogate identifier is exchanged between the SSP and the financial system to identify the user or user device and is generally unrelated to the information maintained at the financial system. The surrogate identifier can be persistent over multiple transactions or variable from transaction-to-transaction, depending on the application. It can be generated using any suitable technique, such as a random or pseudo-random number generator, cryptographic hash algorithm or other hashing algorithm, and the like using any seed, such as all or a portion of the user's credential or additional information. The verification system and financial system can map the credentials of the payer user and/or user device electronic address or other identifier to the surrogate identifier. The surrogate identifier can be is a token or hash or some other hiding technique that is used by the verification system or financial system to associate the payer user with an account number at the financial system.

Commonly, at the behest of a user, the vendor system requests a credential from the verification system. This request can be made either directly to the verification system or through a gateway.

As it may be appreciated, the provider might have “front-end” systems as well as “back-end” service component systems. In many, but not all instances, the front-end might be operated by an operator and in some cases the operator and the user might be the same.

For example, a cashier swipe or enter card information into a point of sale (POS) system (front-end), which is connected to a back-end service for processing. As may be appreciated, in many instances, it might be a user (and not the cashier) who scans, swipes or enters card information into a POS or web portal or mobile device for a transaction.

Upon receiving this request, the verification system can generate a token for the vendor system and provide it to the vendor system.

This token can identify the vendor system and include a variety of information pertaining to the vendor system. Such information might include a description of the value being offered by the vendor as well as where the credential is to be sent. The address to where the credential is to be sent may point to the vendor itself and in particular to a specific front-end or to an agent of the vendor.

As an example, an agent might be a travel agent that works onsite or remotely for a Travel Management Company (TMC). In this example, the terminal, which might be a personal computer, a tablet, a mobile device or some other connected device, is the front-end. The terminal is often connected to the back-end service of the TMC or another party such as a Global Distribution System (GDS) or both.

The vendor system can transfer the token to the user and this transfer can be facilitated manually, electronically, wirelessly including means such as an image, sound, etc., as well as over phone lines or over the interne or other network using fixed, hardline connections or wireless connections or both.

The user can then transfer that token along with other information as described above to the verification system. The transfer of the token and the additional information can be directly to the verification system or through a gateway and can be done in one or more encrypted or unencrypted communications.

Once the token and the additional information is received by the verification system, it is provided to the AS function which validates the additional information and checks the validity of the token with the verification system. The interaction between the AS function and verification system may be loosely coupled and could also be in the form of a publish-subscribe model—i.e. the verification system publishes the token to the AS function is a secure, encrypted manner.

The AS function, upon validating the token as well as the additional information provided, can extract the relevant information and send it to the CAS function. The CAS function may alternatively or additionally reside at a third-party financial system that has the ability to identify the user and authorize the payment or transfer of other value sought by the vendor.

It is intended that a user might have relationships with multiple entities and therefore there might be multiple CAS functions in different systems. Similarly, each CAS function supports multiple users.

Once the CAS function has processed and established the identity and other parameters, proof of payment or payment authorization or other value is sent from the CAS function to the AS function and then on to the vendor system. It might also be the case that the proof of payment or payment authorization as well as other subsequent value items may be sent direct from the entity at which the CAS function resides to the vendor system or its agent.

The verification system can further generate an invoice to charge the vendor system for user access provided by the advertisement of the publisher system. As noted, the publisher ID, advertisement mechanism ID, and context descriptor(s) incorporated by way of the advertisement tag in the token or concatenated to the token establish the role played by the corresponding advertisement to the transaction between the user and vendor. The invoice can be forwarded to the vendor system and/or publisher system for payment.

Each of the services (e.g., the publisher system, financial system, vendor system, and verification system) can have a distributed, encrypted ledger L that is associated with it. For example, a distributed encrypted ledger can be maintained by each of the verification system, information provider system, user device, and vendor system. The purpose of the ledger is to maintain a record of every transaction in the system—e.g., every token issued, every credential authorized by a user, every transaction involving the user that is approved by the verification system, advertisement information (e.g., all or part of the advertisement tag) involved in the transaction, and every transfer of value from the financial system to the vendor system and from the vendor system to the user. These ledgers all communicate with each other using existing well known internet protocols as well as other well known protocols that operate on wireless, wire-line, optical or other communicating means to update the transactions in each ledger. The transfer of value is verified repeatedly through the ledgers such that the transfer of value can be interrupted, delayed or reversed in the event that the ledgers do not tie.

The settlement of the ledger indicates that all the transactions have been validated and issued by the appropriate sub-system. Settlement can be performed by each of the verification system, financial system, user device, and vendor system. Transaction details received from another of the verification system, information provider system, user device, and vendor system can be compared against stored values maintained in local memory of the receiving verification system, financial system, user device, and vendor system, as the case may be. Any intrusion into the system will result in the ledger recording one or more transactions that do not reconcile and this lack of reconciliation results in the suspension of transactions at the points of reconciliation failure. Since the ledger can be encrypted, the fraudulent manipulation of the ledger is difficult. Since the ledger can be distributed, there is no one central authority that maintains the ledger and therefore there is not a specific, central point of manipulation of the ledger.

A difference from conventional methods can be tying or linking authorization for consumption of value to the user instead of any particular device or credential. The advantage of this difference is that the sharing of credentials for unauthorized consumption is curtailed.

For example, access to a streaming service or gaming service or some other entertainment can now be specifically tied to a user or a set of users (—e.g. a family) as opposed to a particular device.

In another example, access to a subscription service, can then be tied to a user rather than a particular device or credential.

In other examples, access can be tied more deeply to the user device than to the user or tied equally to the user device and user.

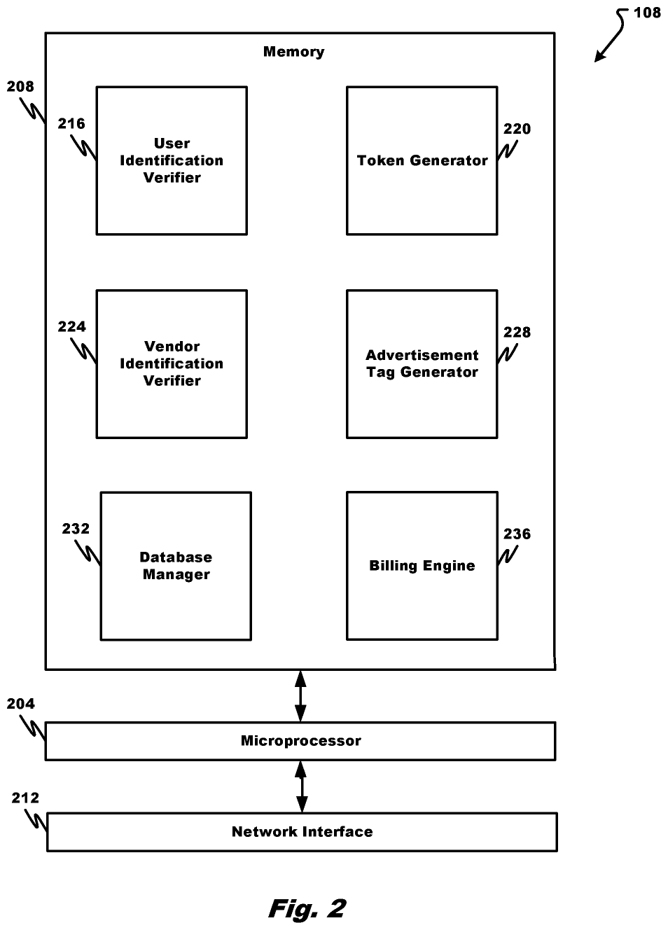

An online commerce system 100 is depicted for performing online transactions between a user and a vendor. The system 100 includes one or more components, which may be hardware and/or software that can be included in one or more computer systems, as described in FIG. 2. The components may include one or more of, but is not limited to, one or more user devices 102a-b, a network 110, a verification system 108 and attached database 114b, a vendor system 116, a publisher system 124 and attached database 114a, and/or a financial system 120 with an attached database 114c. Each of these components will be described hereinafter.

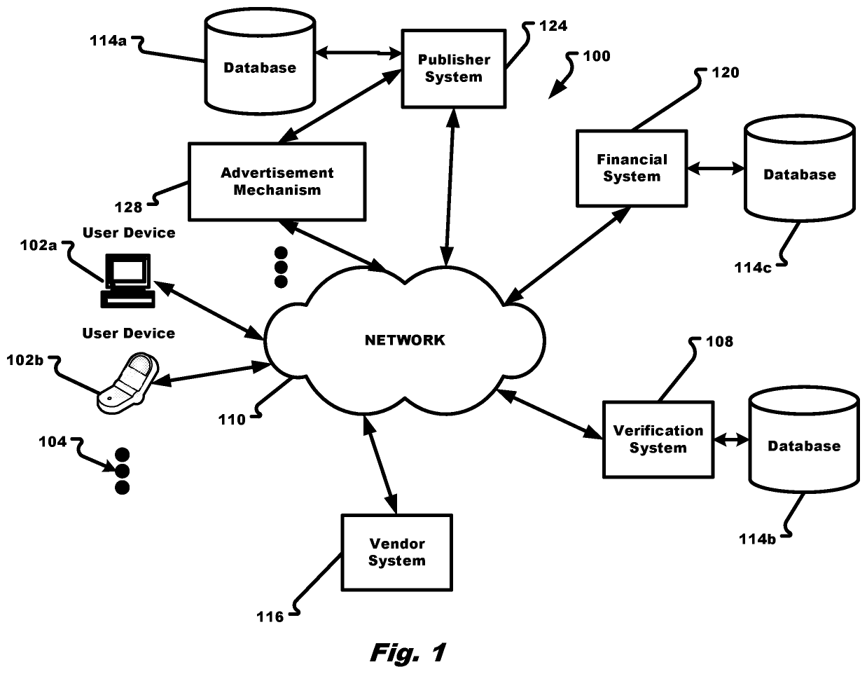

A user device 102 can be any computer system or device used by a person or entity seeking to purchase a product or service from the vendor system 116. Thus, the user device may be represented by a laptop or desktop computer 102a, a user mobile device 102b, or one or more other types of user devices. There may be more or fewer user devices than those shown in FIG. 1, as represented by ellipses 104. A user can be any person, whether a person or organization, that desires to obtain a product, service, or other value from a vendor.

The product or service of the vendor can be any product or service. In one example, the product is a physical product or device. In another example, the product is a digital product, such as streaming or other access to digital media or programming. In another example, the service is license permission to execute or access software or media content licensed to the user or user device.

The financial system 120 is a computer system or device, such as a server, of a custodian, possessor, software or media provider or vendor, financial institution, and the like that is authorized to maintain and access the financial information in the database 114c. Exemplary financial information includes user account information, user credentials, and other user information. The financial system 120 may or may not be related to the verification system 106; that is, the financial system 120 and verification system 108 may or may not be co-located or be part of a common enterprise network. They may be operated by a common entity or by unrelated entities. The financial system 120 processes payment for an online order and can confirm that the user has sufficient funds for the transaction.

The network 110 can be any distributed processing network used to communicate information between two or more computer systems. In embodiments, the network 110 may also represent phone systems or other means of communicating information from a user device to the verification system 108, from the verification system 108 to the vendor system 116, and between the financial system 120 and the verification system 108. Thus, the network 110 can represent systems or networks for completing phone orders or other types of communication systems. A network 110 can communicate in any protocol or format. The network 110 can be an intranet, the Internet, the World Wide Web, etc. In other embodiments, the network 110 may be a public switched telephone network (PSTN) or other type of phone system.

The verification system 108 is a computer system or device, such as a server, that can provide not only CA, CRA, and/or AS functionality for user and vendor system credentials and tokens but also associate user orders from the vendor system with advertisements of the publisher system 124. The attached database 114b can include information relating to vendor tokens, user and user device credentials, publisher system invoicing, and the like. The verification system 108 is described in detail below.

The vendor system 116 is a computer system or device, such as a server, of a vendor, and the like that advertises, offers to sell, and sells the product or service described in the advertisement. The vendor system 116 can include hardware and/or eCommerce software that is operable to receive and process online or other orders from users and cause shipment or provision of purchased product(s) or service(s). In some embodiments, the vendor system 116 comprises a static or dynamic website, or collection of web pages and related content identified by a common domain name and published on a web server. The website can present to user devices media, multimedia, and/or interactive content regarding the products or services offered by the vendor. In one embodiment, the vendor system 116 includes a web server (that receives a user order), computer-based ordering system or manager that queries a stock database (not shown) to find out whether the product or service the customer wants is actually in stock; when the item is in stock, continues to process the order; communicates with the financial system (e.g., run by a credit-card processing firm or linked to a bank) to process payment using the customer's credit or debit card number; authorizes the transaction to go ahead, though funds will not be completely transferred until several days later; confirms that the transaction has been successfully processed and notifies the Web server accordingly; shows the customer a Web page confirming that her order has been processed and the transaction is completed; sends a request to the warehouse to dispatch or provide the product or service to the customer; and, once the product or service has been dispatched or provided, e-mails the customer to confirm that her product or service are on their way, and inventory management system or stock database that receives a query and confirms whether the product or service is in stock or suggests an estimated delivery date when supplies will be received from the manufacturer.

The publisher system 124 is a computer system or device, such as a server, of an information publisher that advertises selected content on the network 110, such as in the form of one or more web pages provided by a web server of the vendor system or different third party system. The publisher system 124, for example, can be an Internet Service Provider (ISP), search engine, or other content provider. In one application, the publisher system 124 comprises software that is designed to carry out web searches (Internet searches) requested by a web browser of a user device that search the World Wide Web in a systematic way for particular information specified in a textual web search query. The search results are generally presented in a line of results or search engine results pages (SERPs). The information may be a mix of links to web pages, images, videos, infographics, articles, research papers, and other types of files. The publisher system 124 can mine data available in databases or open directories. Unlike web directories, which are maintained only by human editors, the publisher system 124 can also maintain real-time information by running an algorithm on a web crawler.

The publisher system 124 can track search history and user device actions, such as mouse cursor movements, to determine context surrounding a search query and search. Mouse cursor movement or click tracking software/hardware can, using tags, record mouse clicks and taps (e.g., on mobile devices) and collect and display the resulting data numerically, visually (e.g., heat maps), or by individual sessions (e.g., session recordings). Click tracking can measure and report where users click or tap on websites (e.g., on a homepage or content-specific landing page) to attribute conversions, measure user engagement, link an order with a specific web page or web page portion, and identify website errors and optimization opportunities with respect to the website or web page design. The publisher system 124 can also track search history by recording, when the user clicks search result links, the sites visited by the user can access and record the user's search terms and IP or network address, which can determine the location of the user device. The context collected from the click tracking and tracked search history is commonly maintained in the publisher system database 114a.

Each of the databases 114a-c can be any database or storage system that stores and accesses an organized collection of data electronically by a database management system. The database can be in use any database model, such as a hierarchical, network, inverted file, relational, graph, multivalue, flat file, and object-oriented database model. It can be an in-memory, active, cloud, distributed, federated, probabilistic, real-time, or other type or configuration of database.

An embodiment of the verification system 108 is described in conjunction with FIG. 2. The verification system 108 is further shown to include a processor 204, memory 208, and a network interface 212. These resources may enable functionality of the verification system 108 as will be described herein.

For instance, the network interface 212 provides the verification system 108 with the ability to send and receive communication packets or the like over the network 110. The network interface 212 may be provided as a network interface card (NIC), a network port, drivers for the same, and the like. Communications between the components of the verification system 108 and other devices connected to the network 110 may all flow through the network interface 212.

The processor 216 may correspond to one or many computer processing devices. For instance, the processor 216 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 216 may be provided as a microprocessor, Central Processing Unit (CPU), or plurality of microprocessors that are configured to execute the instructions sets stored in memory 208.

The memory 208 may include any type of computer memory device or collection of computer memory devices. The memory 208 may be volatile or non-volatile in nature and, in some embodiments, may include a plurality of different memory devices. Non-limiting examples of memory 208 include Random Access Memory (RAM), Read Only Memory (ROM), flash memory, Electronically-Erasable Programmable ROM (EEPROM), Dynamic RAM (DRAM), etc. The memory 208 may be configured to store the instruction sets depicted in addition to temporarily storing data for the processor 216 to execute various types of routines or functions. Although not depicted, the memory 208 may include instructions that enable the processor 216 to store data into the database 114b and retrieve information from the database.

Illustrative instruction sets that may be stored in memory 208 include, without limitation, a user identification verifier instruction set 216, a token generator instruction set 220, a vendor identification verifier instruction set 224, an advertisement tag generator instruction set 228, a database manager instruction set 232, and a billing engine instruction set 236. Functions of the verification system 108 enabled by these various instruction sets will be described in further detail herein. It should be appreciated that the instruction sets depicted in FIG. 2 may be combined (partially or completely) with other instruction sets or may be further separated into additional and different instruction sets, depending upon configuration preferences for the verification system 108. Said another way, the particular instruction sets depicted in FIG. 2 should not be construed as limiting embodiments described herein.

In some embodiments, the user identification verifier instruction set 216, when executed by the processor 204, may verify, authenticate, or validate the identities of the user and/or user device. This is done, for the user device, by comparing one or more of an electronic address or physical location of the user device or the user, a session identifier (including web, mobile device, tablet, etc.), or other identifier of the user device (such as a serial number) with one or more stored parameters or variables and, for the user, by comparing one or more of a name or credential of the user, a session identifier (including web, mobile device, tablet, etc.), other pertinent information (including an additional identifier assigned to the user, answers to one or more predetermined questions for authentication of the user, etc.), and the like with one or more stored parameters or variables. When the comparison matches, the user and/or user device, as the case may be, is verified, validated or authenticated successfully. When a comparison does not match, the user and/or user device, as the case may be, is not verified, validated or authenticated successfully.

In some embodiments, the token generator instruction set 220, when executed by the processor 204, may generate and provide to the vendor system a vendor token. The token generator instruction set generates and/or assigns the token to the vendor system. In one embodiment, the token is generated using a random or pseudo-random number generator. As will be appreciated, a random or pseudo-random number generator is a computational or physical device designed to generate a sequence of numbers or symbols that lack any pattern, i.e. appear random or pseudo-random. The random or pseudo-random number generator automatically creates sequences of numbers with apparent random properties but eventually the sequence repeats (or the memory usage grows without bound). The series of values generated by such algorithms is generally determined by a fixed number called a seed. The generator can use any suitable algorithm, such as the linear congruential generator, middle square method, a function or library routine in a selected computer programming language (e.g., for example/dev/random on various BSD flavors, Linux, Mac OS X, IRIX, and Solaris, or CryptGenRandom for Microsoft Windows™), the multiply-with-carry method, generation from a probability distribution (e.g., by the inversion or acceptance-rejection method), and the like. While the seed can be any variable, typical seeds include an electronic address or physical location of the vendor system or a selected person or entity, other identifier of the vendor system (such as a serial number), a name of a selected person or entity associated with the vendor system, a session identifier (including web, mobile device, tablet, etc.), and the like. The verification system can generate and provide the token to the vendor system at any time. When generated before the transaction, the token may be embedded in an advertisement for a product or service and provided to the vendor and/or verification systems as part of an order from a user or user device.

In some embodiments, the vendor identification verifier instruction set 224, when executed by the processor 204, may verify, authenticate, or validate the identity of the vendor system. This is typically done for the vendor system by comparing one or more of an electronic address or physical location of the vendor system or a selected person or entity, other identifier of the vendor system (such as a serial number), a name of a selected person or entity associated with the vendor system, a session identifier (including web, mobile device, tablet, etc.), other pertinent information, and the like with one or more stored parameters or variables. When the comparison matches, the vendor system is validated or authenticated successfully. When a comparison does not match, the vendor system is not validated or authenticated successfully.

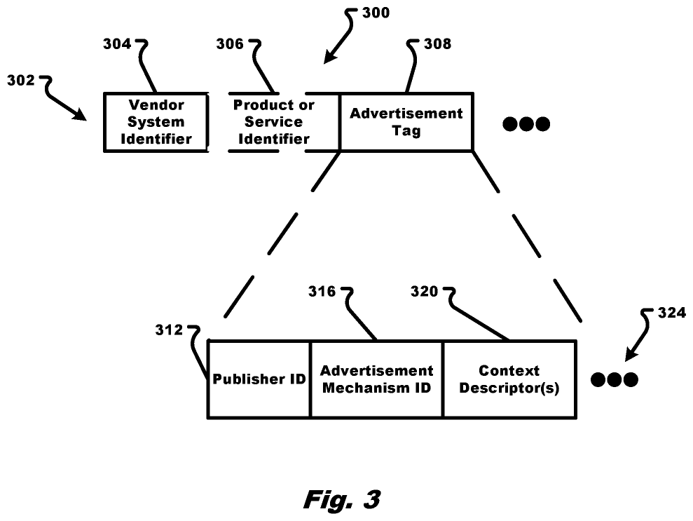

In some embodiments, the advertisement tag generator instruction set 228, when executed by the processor 204, may generate an advertisement tag that is incorporated into or concatenated to the token. The advertisement tag can be generated using order information received from the vendor system and click tracking data and/or search history tracking data associated with the interaction with the user and user device that produced the order. The order information, for example, could include an identity of the publisher system associated with the web page of the advertisement that generated the order and the identifier of the publication mechanism corresponding to the advertisement that generated the order. The advertisement tag is discussed in detail below with respect to FIG. 3.

In some embodiments, the database manager instruction set 232, when executed by the processor 204, may handle the storage, retrieval, and updating of data in the database 114b. The database manager instruction set (DBMS) is the logic that interacts with the verification system components and the database to capture and analyze the transaction and vendor data and update and reconcile the distributed ledger at the verification system.

In some embodiments, the billing engine 236, when executed by the processor 204, may determine and generate, on behalf of the publisher system, invoice information to be charged to the vendor arising from the sale related directly to the advertisement of the publisher system. The invoice can be based on any rate schedule and triggered by any event in the transaction (e.g., order placement, order fulfillment or completion, and the like).

FIG. 3 depicts a token data structure 300 according to an embodiment. The data structure, which can be stored in memory (not shown) of the verification system and/or the database 114b, includes a vendor tag field 304, optional product or service identifier field 306, and advertisement tag field 308. The vendor tag field 304 is typically assigned to the vendor system by the token generator instruction set. In one embodiment, the vendor token field 304 includes an electronic address, device identifier or ID of the vendor system, unique name of an entity associated with the vendor system, pair-wise name of the vendor system, and/or a random number identifier or ID.

The product or service identifier field 306 is a description of the product or service previously requested or authorized to be provided to the vendor system.

The advertisement tag 308 can include the publisher ID field 312 associated with the publisher system providing the source advertisement for the order, the advertisement mechanism ID 316 of the source advertisement that links or otherwise associates the identifier of an advertisement mechanism and/or modality with the source advertisement, and/or one or more descriptor(s) of the context of the advertisement and the successful sales transaction and provide a set of advertisement data structures that reflect not only the transaction details or data structures (e.g., vendor identity, date and amount of sale, identifiers or products or services sold, and purchaser or user details (such as the user identity)) but also the details regarding the source advertisement and its role in the transaction.

As shown by the ellipses 324, the token data structure 300 can include other information, depending on the type of transaction.

As noted, the vendor token field 304 or the entire token data structure 300 can be generated by a random or pseudo-random number generator using one or more of these variables as a seed.

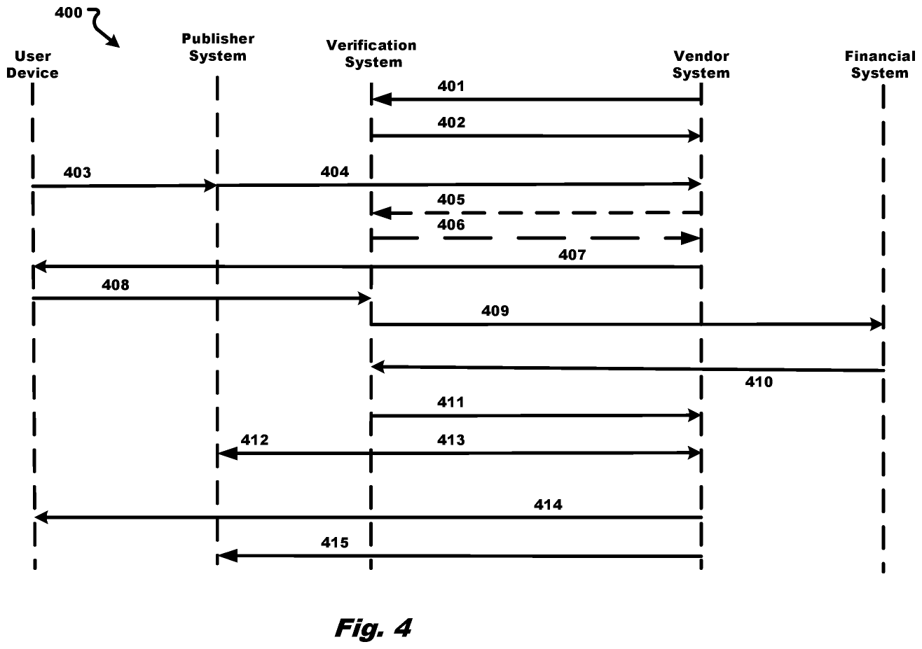

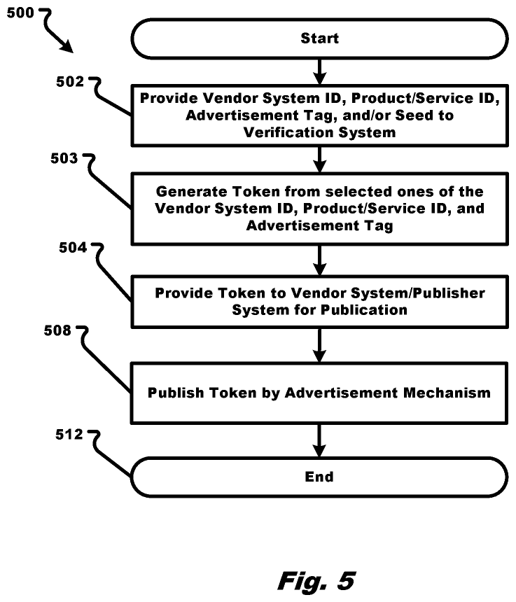

An operation of the verification system will now be discussed with reference to FIGS. 4 and 5. FIG. 4 shows the flow of signals 400, and FIG. 5 shows the logic step sequence 500.

In step 502, the vendor system requests 401 the verification system (processor) to provide it with a token 304 for a selected product or service identifier 306 and/or advertisement tag 308 to be used to advertise the product or service associated with the selected product or service identifier 306. The request can also include the information to be used as a seed in generating the identifier. In one configuration, the seed is an identifier of an entity associated with the vendor system and an identifier of the vendor system (e.g., serial number, electronic address, etc.). In one configuration, the seed is an identifier of an entity associated with the vendor system and an electronic session identifier (e.g., web, mobile, tablet, etc.). The session can be the session in which the vendor system requests a token to be assigned.

In step 503, the verification system 108 generates the token from the provided vendor system ID, product and/or service ID, advertisement tag 308 and seed.

In step 504, the verification system 108 provides 402 the token to the vendor system and/or publisher system for inclusion in an advertisement to be published, such as on a web page, in a catalog, on a billboard, hand bill, and the like.

In step 508, vendor system or publisher system publishes the token in the advertisement. When the token is received, the embedded advertisement tag will link or otherwise associate the identifier of an advertisement mechanism and/or modality, identifier of a publisher or source of the advertisement, and/or one or more descriptor(s) of the context of the advertisement with the transaction and enable the verification system to update the distributed ledgers to reflect not only the transaction details or data structures (e.g., vendor identity, date and amount of sale, transaction identifier, identifiers or products or services sold, and purchaser or user details (such as the user identity)) but also the corresponding advertisement data structures.

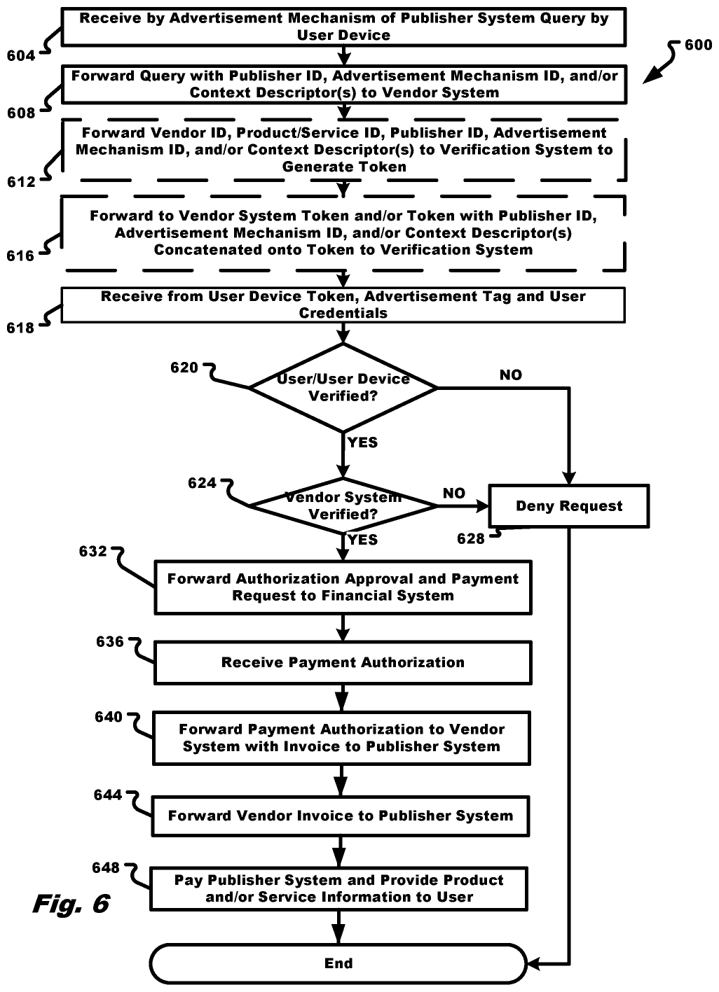

An operation of the verification system will now be discussed with reference to FIGS. 4 and 6. FIG. 4 shows the flow of signals 400, and FIG. 6 shows the logic step sequence 600.

In step 604, the publisher system and/or vendor system receives (403 or 404) by the advertisement mechanism of the publisher system a query by the user device. When the token is generated during (as opposed to before) the transaction, the vendor system in optional step 612 provides 405 to the verification system 108, and the verification system in optional step 612 returns 406 to the vendor system a token defining the vendor, product or service to be purchased, and source advertisement, either in encrypted or unencrypted form. A cryptosystem can be employed when sent in encrypted form.

When a user or customer selects or otherwise expresses an interest in, such as by using a user device 102a, 102b, . . . , or other computational or electronic device (such as a television, laptop or desktop computer, tablet computer, e-Reader, and the like), a product or service from an advertisement (such as a web advertisement or any of the advertisement modalities referenced above), the selection causes the user device to forward the token to the publisher system and/or vendor system as part of the sales transaction. The selection can be by icon or object selection via a graphical user interface, inputting a code (such as associated with a product or service (e.g., a bar code, Radio Frequency Identifier (“RFID”), unique identifiers (such as Globally Unique Identifiers (“GUID”), Global Trade Item Numbers (“GTINs”), Manufacture Part Numbers (“MPNs”), Universal Product Codes (“UPCs”), European Article Numbers (“EANs”), Japanese Article Numbers (“JANs”), International Standard Book Numbers (“ISBNs”), and Electronic Product Code (“EPC”)), a coupon, an offer, or other transaction-related item), image processing software (such as Vivino™ and other algorithms for processing an image (such as a video or photograph) to extract the code), or other techniques known to a skilled artisan.

In some implementations, the vendor system can provide 407 the token and/or advertisement tag to the user device by manual input or by wireless or wired signal transmission. In one configuration, an application on the user device further executes and collects the token and/or advertisement tag through manual or audible input from the user or automatically through signaling exchanged with the vendor system. The application collects, from the user to authenticate the user, one or more of credentials, such as a personal identification number, username, password, and biometric information about the person (such as a picture (e.g., facial image), fingerprint, retinal scan, and the like), and answers to one or more pre-set questions and, from the user device, one or more of an electronic address or other identifier of the user device and an identifier of an application (such as an applet or other application provided by the verification system) on the user device. Prompting of additional questions may depend on, but not limited to, geography, risk profile of the person or information provider, type of information to be exchanged, and the like.

In step 618, the verification system receives 408 from the user device over a secure channel using a cryptographic system the token, advertisement tag and user/user device credentials and user answers and one or more of an electronic address or other identifier of the user device and an identifier of an application for verification.

In decision diamond 620, the verification system, using the collected information, verifies, authenticates, and/or validates the user and/or user device by comparing the collected information against known or previously stored variables for the user and/or user device. If the user or user device is verified, authenticated, and/or validated successfully, the verification system proceeds to decision diamond 624.

In decision diamond 624, the verification system, using the token, verifies, authenticates, and/or validates the vendor system by comparing the collected information against known or previously stored variables for the vendor system. If the vendor system is verified, authenticated, and/or validated successfully, the verification system proceeds to step 632.

When the verification system is unable to successfully verify, authenticate, or validate the user, user device, or vendor system, the verification system, in step 628, denies the transaction request and records the transaction details and result in the distributed ledger. As will be appreciated, verification, authentication, or validation will fail when the collected information do not precisely match stored variables for the user, user device, or vendor system (as appropriate).

In step 632, when verification, authentication, or validation of the user/user device and vendor system is successful, the verification system records the transaction details in the distributed ledger and forwards 409 payment authorization approval and/or payment request to the user's financial system and in step 636 receives 410, over a secure channel using a cryptographic system, from the user's financial system one or more of payment authorization confirmation from the user's account at the financial system to the vendor system, confirmation that the user's account has sufficient funds to pay for the transaction, payment settlement details, and/or other information adequate to confirm user payment to the vendor. A surrogate identifier can also be provided to the financial system to identify one or more of the transaction, user, user device, and vendor system and an indication of successful verification, authentication, or validation.

In step 640, the verification system provides 411, over a secure channel using a cryptographic system, the payment authorization and, on behalf of the publisher system, an invoice for use of the source advertisement to the vendor system.

In step 644, the verification system provides 411, over a secure channel using a cryptographic system, the invoice to the publisher system.

In step 648, the vendor system pays the publisher system for the source advertisement and provides the product and/or service to the user.

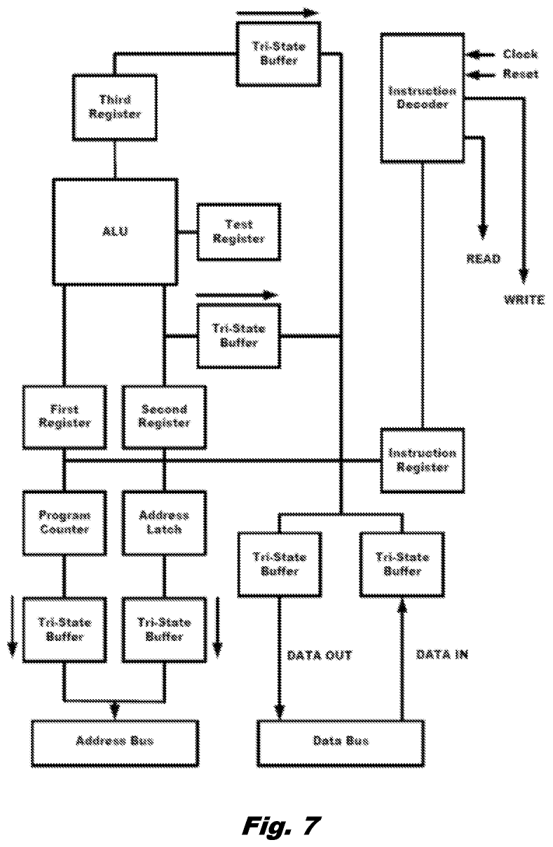

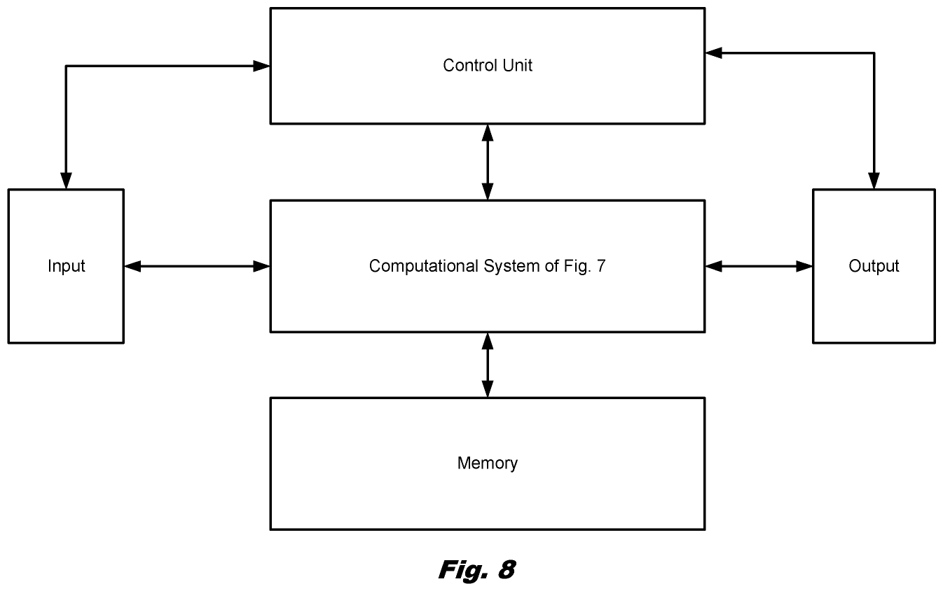

With reference to FIGS. 7-8, the verification system 108 can perform any of the operations or functions set forth above using an arithmetic logic unit (“ALU”) system in addition to or in lieu of the processor, which performs mathematical, arithmetic, and/or logic in response the execution of one or more instructions operations, such as addition, subtraction, multiplication, and division, machine instructions, an address bus (that sends an address to memory), a data bus (that can send data to memory or receive data from memory), a read and write line to tell the memory whether to set or get the addressed location, a clock line that enables a clock pulse to sequence the processor, and a reset line that resets the program counter to zero or another value and restarts execution. The arithmetic logic unit can be a floating-point processor that performs operations on floating point numbers. The arithmetic logic unit can, for instance, perform logical operations (such as AND, OR NOT, XOR, NOR, NAND, etc.), bit shifting operations (e.g., shifting positions of bits by a determined number of places to the right or left), and/or arithmetic (e.g., bit addition and subtraction) operations. As shown in FIG. 8, the ALU can work in conjunction with (and under the control of) a control unit (“CU”) that extracts instructions from memory and decodes and executes them. The verification system 108 can further include first, second, and third registers that are typically configured from flip-flops, an address latch, a program counter (which can increment by “1” and reset to “0”), a test register to hold values from comparisons performed in the arithmetic logic unit, plural tri-state buffers to pass a “1” or “0” or disconnect its output (thereby allowing multiple outputs to connect to a wire but only one of them to actually drive a “1” or “0” into the line), and an instruction register and decoder to control other components. Control lines, in the verification system, from the instruction decoder can: command the first register to latch the value currently on the data bus, command the second register to latch the value currently on the data bus, command the third register to latch the value currently output by the ALU, command the program counter register to latch the value currently on the data bus, command the address register to latch the value currently on the data bus, command the instruction register to latch the value currently on the data bus, command the program counter to increment, command the program counter to reset to zero, activate any of the plural tri-state buffers (plural separate lines), command the ALU what operation to perform, command the test register to latch the ALU's test bits, activate the read line, and activate the write line. Bits from the test register and clock line as well as the bits from the instruction register come into the instruction decoder. Hardware similar or identical to that of FIG. 7 can be not only in the verification system 108 but also in the database 114 or computational systems of the financial system, vendor system, user or user device, or publisher system. The ALU, for example, can execute any of the instruction sets in the verification system 108, including the user identification verifier 216, token generator 220, vendor identification verification 224, advertisement tag generator 228, database manager 232, or billing engine 236.

For example, the token and/or advertisement tag is generated by the ALU executing algorithm instructions received from the local memory and is written to local memory, in response to a write command output by the instruction decoder, and at an address provided to memory by the ALU via the program counter and/or address latch via the address bus, with the data being provided to local memory via the data bus.

Verification, authentication, and/or validation can be performed for each of the user, user device, publisher system, and vendor system using the ALU and test register. The ALU normally compares first and selected numbers and determines if they are equal, if one is greater than the other, or if one is less than the other. The test register can hold a carry bit from the last stage of the adder. The test register stores these carry bit values in flip-flops and then the instruction decoder can use the values to make decisions. The ALU sequentially and independently compares first (received) and second (stored) values each of the user, user device, and target device (or third party operating the target device) to sequentially and independently confirm that the first and second values are identical and therefore that verification, authentication, and/or validation is successful. When the first value is greater than the second value or less than the second value, verification, authentication, and/or validation is not successful. When a comparison is performed by the ALU, the carry bit indicates whether or not the comparison matched.

The second values are read from local memory by a read command issued by the instruction decoder, with the read data being located at an address provided to the local memory by the address bus and output by the ALU and program counter and/or address latch, with the read data being received from local memory via the data bus.

When the verification system is unable to successfully verify, authenticate, or validate the user, user device, publisher system, or vendor system, the verification system denies the transaction request and records the transaction details and result, in response to a write command issued by the instruction decoder at a memory address provided by the ALU via the program counter and/or address latch and provided to local memory via the address bus. The transaction details and result are provided to local memory by the data bus. As will be appreciated, verification, authentication, or validation will fail when the collected information do not precisely match stored variables for the user, user device, publisher system, or vendor system (as appropriate).

The ALU can determine the contribution of the publisher system by mapping the information in the advertisement tag to a set of data structures, such as a table or list, that indexes selected information in the tag against contribution levels or amounts. For instance, one or more of the identifier of a publisher of the source advertisement, identifier of an advertisement mechanism for the source advertisement, and descriptor(s) of the context of the source advertisement can be mapped to the set of data structures to yield a matching contribution level.

As used herein, the phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A “computer readable signal medium” may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

A “credential”, as used herein, refers to an attestation of qualification, competence, authority, or identity issued to an individual by another entity with a relevant or de facto authority or assumed competence to do so or attestation of authority or identity selected by the user himself or herself. Examples of credentials include academic diplomas, academic degrees, certifications, security clearances, identification documents, badges, passwords, user names, personal identification numbers, digital signatures, security keys (e.g., symmetric and asymmetric keys, such as private or public key for a cryptographic protocol), powers of attorney, login strings (e.g., username and password), machine-readable cryptographic public or private keys and other user authentication and/or verification information.

The terms “determine”, “calculate” and “compute,” and variations thereof, as used herein, are used interchangeably and include any type of methodology, process, mathematical operation or technique.

The term “Internet Service Provider” or ISP, as used herein, refers to an entity that provides third parties access to the Internet. An ISP has the equipment and the telecommunication line access required to have a point-of-presence on the Internet for the geographic area served. An ISP acts as an intermediary between its clients computer system and the Internet. ISPs take several forms, such as telephone and cable companies, online services, large national ISPs, and small independent ISPs, and offer a wide variety of services.

The term “Internet search engine”, as used herein, refers to is a software system that is designed to carry out web searches (Internet searches), which means to search the World Wide Web in a systematic way for particular information specified in a textual web search query. The search results are generally presented in a line of results, often referred to as search engine results pages (SERPs). The information may be a mix of links to web pages, images, videos, infographics, articles, research papers, and other types of files. Some search engines also mine data available in databases or open directories. Unlike web directories, which are maintained only by human editors, search engines also maintain real-time information by running an algorithm on a web crawler. Internet content that is not capable of being searched by a web search engine is generally described as the deep web. The search engine commonly maintains the following processes in real time, web crawling, indexing, and searching.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “token” or “tag” as used herein refers to a sequence of characters and/or symbols describing a desired object. The token or tag can be in plain text or encrypted, depending on the application.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. In another example, the advertisement tag can be used in other sale transaction methodologies to associate an advertisement with the sale of a product or service. For example, the token can be generated by the verification system for the user or user device and include user credentials and/or account information and provided to the vendor system, which in turn provides the token to the verification system. The token includes the advertisement tag. In another example, the advertisement is in the form of a printed or displayed advertisement, such as a sign, billboard, handbill, catalog, television commercial, and the like and the vendor system receives the token from the user device as part of a transaction. The token can be received, for instance, from the user or user device in the form of an image or as input from a customer service representative. In another example, the advertisement is displayed as part of a web page, and the vendor system receives the token from the user device as part of an Ecommerce transaction. The token can be received, for instance, from the user device through user selection of a link or icon that generates a request to the vendor regarding possible purchase of the product or service.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
generating, by a processor, a token comprising information describing one or more of a product or service provided by a vendor and an advertisement tag, the advertisement tag comprising an identity of a publisher of an advertisement regarding the product or service, the publisher being different from the vendor;
as part of a request by a user relating to the product or service, receiving, by the processor, the token;
determining, by the processor, a contribution of the publisher's advertisement to the request; and
updating, by the processor, a set of transaction data structures in an electronic record to associate the identified publisher and the contribution with the request.

2. The method of claim 1, wherein the request is part of a sales transaction for the product or service, wherein the token is included in the advertisement, and wherein the publisher is one or more of an Internet Service Provider (ISP) and search engine.

3. The method of claim 2, wherein the contribution comprises a monetary charge for the advertisement, wherein the information in the token comprises a unique identifier of the vendor providing the product or service and a product or service identifier of the product or service, and further comprising:
providing, by the processor, the token to a computational system associated with the vendor or the publisher;
receiving, by the processor from a user device associated with the user and as part of an electronic session and transaction, a user identifier and the token included in the advertisement selected by the user device;
authenticating, by the processor, the user identifier, as part of the transaction; and
when the user is authenticated by the processor successfully, providing, by the processor, an authorization to a financial system associated with the user to cause payment from an account of the user to an account of the vendor.

4. The method of claim 3, further comprising:
receiving, by the processor, a response from the financial system indicating payment by the user for the product or service; and
in response to receipt of the financial system response, providing, by the processor, at least part of the response to the vendor system, the at least part of the response comprising an identity of a publisher of the advertisement, an identifier of an advertisement mechanism associated with the advertisement, and/or a descriptor of a context of the advertisement and a product or service identifier of the product or service and an electronic session identifier associated with the electronic session and/or a transaction identifier associated with the transaction to cause the vendor system to authorize provision of the product or service to the user.

5. The method of claim 1, wherein the advertisement is included in a search engine results page and wherein the advertisement tag further includes an identifier of an advertisement mechanism associated with the advertisement, the advertisement mechanism being a banner ad, sidebar ad, pop-up ad, pop-under ad, floating ad, unicast ad, streaming ad, pull-up ad, pull-down ad, and combination thereof.

6. The method of claim 1, wherein the advertisement is included in a web page of a web site, wherein the web page contains the token in a field defined by hypertext markup language, wherein the advertisement tag comprises one or more descriptors of a context of the advertisement, and wherein the one or more descriptors describes a sequence of clicks by the user and a search history of the user.

7. The method of claim 1, wherein the advertisement is a printed or displayed advertisement and wherein the processor receives the token from the user device as an image or as input from a customer service representative.

8. The method of claim 6, wherein the token comprises or is concatenated with a second advertisement tag comprising a different second publisher, the second publisher being responsible for a second web page provided to a user device during navigation by the user from the web page of the web site.

9. A system, comprising:
a processor; and
a memory coupled with and readable by the processor and storing therein a set of instructions which, when executed by the processor, causes the processor to:
generate a token comprising information describing one or more of a product or service provided by a vendor and an advertisement tag, the advertisement tag comprising an identity of a publisher of an advertisement regarding the product or service, the publisher being different from the vendor;
receive the token as part of a request by a user relating to the product or service;
determine a contribution of the publisher's advertisement to the request; and
update a set of transaction data structures in an electronic record to associate the identified publisher and the contribution with the request.

10. The system of claim 9, wherein the request is part of a sales transaction for the product or service, wherein the token is included in the advertisement, and wherein the publisher is one or more of an Internet Service Provider (ISP) and search engine.

11. The system of claim 10, wherein the contribution comprises a charge for the advertisement, wherein the information in the token comprises a unique identifier of the vendor providing the product or service and a product or service identifier of the product or service, and wherein the set of instructions, when executed by the processor, further cause the processor to:
provide the token to a computational system associated with the vendor or the publisher;
receive, from a user device associated with the user and as part of an electronic session and transaction, a user identifier and the token included in the advertisement selected by the user device;
authenticate the user identifier, as part of the transaction; and
when the user is authenticated by the processor successfully, provide an authorization to a financial system associated with the user to cause payment from an account of the user to an account of the vendor.

12. The system of claim 11, wherein the set of instructions, when executed by the processor, further cause the processor to:
receive a response from the financial system indicating payment by the user for the product or service; and
in response to receipt of the financial system response, provide at least part of the response to the vendor system, the at least part of the response comprising an identity of a publisher of the advertisement, an identifier of an advertisement mechanism associated with the advertisement, and/or a descriptor of a context of the advertisement and a product or service identifier of the product or service and an electronic session identifier associated with the electronic session and/or a transaction identifier associated with the transaction to cause the vendor system to authorize provision of the product or service to the user.

13. The system of claim 9, wherein the advertisement is included in a search engine results page and wherein the advertisement tag further includes an identifier of an advertisement mechanism associated with the advertisement, the advertisement mechanism being a banner ad, sidebar ad, pop-up ad, pop-under ad, floating ad, unicast ad, streaming ad, pull-up ad, pull-down ad, and combination thereof.

14. The system of claim 9, wherein the advertisement is included in a web page of a web site, wherein the web page contains the token in a field defined by hypertext markup language, wherein the advertisement tag comprises one or more descriptors of a context of the advertisement, and wherein the one or more descriptors describes a sequence of clicks by the user and a search history of the user.

15. The system of claim 9, wherein the advertisement is a printed or displayed advertisement and wherein the processor receives the token from the user device as an image or as input from a customer service representative.

16. The method of claim 14, wherein the token comprises or is concatenated with a second advertisement tag comprising a different second publisher, the second publisher being responsible for a second web page provided to a user device during navigation by the user from the web page of the web site.

17. A system, comprising:
a processor; and
a memory coupled with and readable by the processor and storing therein a set of instructions which, when executed by the processor, causes the processor to:
receive an advertisement tag as part of a request by a user relating to the product or service, the advertisement tag comprising an identity of a publisher of an advertisement regarding a product or service offered by a vendor, the publisher being different from the vendor;
determine a contribution of the publisher's advertisement to the request; and
update a set of transaction data structures in an electronic record to associate the identified publisher and contribution with the request.

18. The system of claim 17, wherein the request is part of a sales transaction for the product or service, wherein the advertisement tag is included in the advertisement, and wherein the publisher is one or more of an Internet Service Provider (ISP) and search engine.

19. The system of claim 18, wherein the contribution comprises a charge for the advertisement, wherein the advertisement tag is part of or concatenated with a token, wherein the information in the token comprises a unique identifier of the vendor providing the product or service and a product or service identifier of the product or service, and wherein the set of instructions, when executed by the processor, further cause the processor to:
generate the token;
provide the token to a computational system associated with the vendor or the publisher;
receive, from a user device associated with the user and as part of an electronic session and transaction, a user identifier and the token included in the advertisement selected by the user device;
authenticate the user identifier, as part of the transaction; and
when the user is authenticated by the processor successfully, provide an authorization to a financial system associated with the user to cause payment from an account of the user to an account of the vendor.

20. The system of claim 19, wherein the set of instructions, when executed by the processor, further cause the processor to:
receive a response from the financial system indicating payment by the user for the product or service; and
in response to receipt of the financial system response, provide at least part of the response to the vendor system, the at least part of the response comprising an identity of a publisher of the advertisement, an identifier of an advertisement mechanism associated with the advertisement, and/or a descriptor of a context of the advertisement and a product or service identifier of the product or service and an electronic session identifier associated with the electronic session and/or a transaction identifier associated with the transaction to cause the vendor system to authorize provision of the product or service to the user.

21. The system of claim 17, wherein the advertisement is included in a search engine results page and wherein the advertisement tag further includes an identifier of an advertisement mechanism associated with the advertisement, the advertisement mechanism being a banner ad, sidebar ad, pop-up ad, pop-under ad, floating ad, unicast ad, streaming ad, pull-up ad, pull-down ad, and combination thereof.

22. The system of claim 17, wherein the advertisement is included in a web page of a web site, wherein the web page contains the advertisement tag in a field defined by hypertext markup language, wherein the advertisement tag comprises one or more descriptors of a context of the advertisement, and wherein the one or more descriptors describes a sequence of clicks by the user and a search history of the user.

23. The system of claim 19, wherein the advertisement is a printed or displayed advertisement and wherein the processor receives the token from the user device as an image or as input from a customer service representative.

24. The method of claim 17, wherein the advertisement tag comprises or is concatenated with a second advertisement tag comprising a different second publisher, the second publisher being responsible for a second web page provided to a user device during navigation by the user from the web page of the web site.
